(19) United States
(12) Patent Application Publication
(10) Pub. No.: US 2026/0214626 A1
(43) Pub. Date: Jul. 23, 2026

(54) METHODS, APPARATUSES AND SYSTEMS FOR SINGLE POINT POSITIONING OF INTELLIGENT REFLECTION SURFACE INSTALLED USER EQUIPMENT

(71) Applicant: Kyocera Corporation, Kyoto (JP)

(72) Inventor: Amit KALHAN, San Diego, CA (US)

(21) Appl. No.: 19/157,803

(22) PCT Filed: Mar. 21, 2024
(86) PCT No.: PCT/US2024/020864

§ 371 Date: Aug. 19, 2025

Related U.S. Application Data
(60) Provisional application No. 63/455,214, filed on Mar. 28, 2023.

(51) Int. Cl. H04W 64/00; H04B 7/04

(52) U.S. Cl. CPC H04W 64/00; H04B 7/04013

(57) ABSTRACT

Methods, apparatuses and systems for single point positioning of intelligent reflection surface (IRS) installed user equipment (UE). In one embodiment, a wireless communication device includes: a receiver configured to receive a first signal from a wireless communication node and a plurality of second signals from the wireless communication node; and a transceiver configured to reflect each of the plurality of second signals back towards the wireless communication node using an Intelligent Reflecting Surface (IRS) coupled to the wireless communication device for positioning computation of the wireless communication device, wherein the receiver is further configured to receive each of the plurality of second signals at a respective Angle of Arrival (AoA) from a plurality of AoAs, wherein the plurality of second signals covers at least part of a serving area of the wireless communication node.

### TECHNICAL FIELD

The disclosure relates generally to wireless communications and, more particularly, to methods, apparatuses and systems for single point positioning of intelligent reflection surface (IRS) installed user equipment (UE).

### BACKGROUND

An IRS is a planar surface comprising a plurality of small, reconfigurable reflecting elements, each of which can induce a controllable amplitude, phase and/or polarization change to the incident signal independently, without need of baseband processing. IRSs are designed to reflect, refract, or scatter incoming electromagnetic waves in a way that optimizes signal strength, minimizes interference, and enhances overall wireless communication performance.

On the other hand, with the aim of providing high data rate with low-latency and reliable coverage in future generation communication systems, accurate and reliable UE positioning is a crucial aspect as UE positioning information can be used for allocating and managing transmission resources, delivering satisfactory Quality of Service (QOS) to users, enhancing spectrum efficiency, and performing handovers between different base stations (BSs) or cells. UE positioning in wireless communication systems is a challenging task due to various factors and constraints, which can impact the accuracy and reliability of positioning methods. Examples of key challenges in UE positioning include: multipath propagation causing signal delays and distortions, non-line-of-signal (NLOS) conditions, excessive control signaling overhead, accurate time synchronization requirement, and increased power consumption. Therefore, there is a need to develop new systems for improving UE positioning accuracy and reliability while maintaining power consumption at a low level.

### SUMMARY

The exemplary embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

In some embodiments, a wireless communication device includes: a receiver configured to receive a first signal from a wireless communication node and a plurality of second signals from the wireless communication node; and a transceiver configured to reflect each of the plurality of second signals back towards the wireless communication node using an Intelligent Reflecting Surface (IRS) coupled to the wireless communication device for positioning computation of the wireless communication device, wherein the receiver is further configured to receive each of the plurality of second signals at a respective Angle of Arrival (AoA) from a plurality of AoAs, wherein the plurality of second signals covers an entire serving area of the wireless communication node or at least a portion of the serving area of the wireless communication node. In some embodiments, a downlink positioning reference signal (DL-PRS) is reachable within the entire serving or coverage area. However, in some embodiments, the DL-PRS may not be transmitted every time to cover the entire coverage area. In some cases, a set of DL-PRS are transmitted in a specific direction. For example, if the network has a general idea where the UEs are located so it transmits in that general direction to cover only a portion of the coverage/serving area.

In some embodiments, each of the plurality of AoAs is measured at the wireless communication device using one of the following: Capon's Minimum Variance method, MUltiple SIgnal Classification (MUSIC) method, Estimation of Signal Parameters via Rotational Invariance Techniques (ESPRIT) method, and Matrix-Pencil method.

In some embodiments, the first signal includes an indication to instruct the wireless communication device to reflect each of the plurality of second signals back towards the wireless communication node using the IRS with a respective same direction as measured in the respective one of the plurality of AoAs, wherein the indication is: transmitted through system information block (SIB) signaling; transmitted through SIB Type 1 (SIB1) signaling; transmitted through radio resource control (RRC) signaling; transmitted through medium access control-control element (MAC-CE) signaling; transmitted through downlink control information (DCI) signaling; transmitted via a paging message; or pre-configured in the wireless communication device.

In some embodiments, a respective one of the plurality of second signals includes a respective downlink-positioning reference signal (DL-PRS), wherein the respective DL-PRS includes a respective train of DL-PRS pulses, wherein the respective train of DL-PRS pulses includes a respective first subset of DL-PRS pulses and a respective second subset of DL-PRS pulses, wherein: the respective first subset of DL-PRS pulses is used to determine the respective AoA of the respective one of the plurality of second signals; and the respective second subset of DL-PRS pulses is reflected by the IRS towards the wireless communication node with the respective same direction as measured in the respective AoA of the respective one of the plurality of second signals.

In some embodiments, the wireless communication device is in a POSITIONING state when each of the plurality of second signals is reflected back towards the wireless communication node, wherein the wireless communication device is in a listen-only or reflection-only mode in the POSITIONING state.

In some embodiments, the wireless communication node is configured to schedule a plurality of timeslots, wherein: the plurality of timeslots includes non-overlapping timeslots; each of the plurality of timeslots is associated with a respective one of a plurality of wireless communication devices, wherein the plurality of wireless communication devices includes the wireless communication device; and during each of the plurality of timeslots, a respective one of the plurality of wireless communication devices is in communication with the wireless communication node for positioning estimation by reflecting incident signals from the wireless communication node using a respective IRS coupled to the respective one of the plurality of wireless communication devices while all other wireless communication devices in the plurality of wireless communication devices are muted.

### BRIEF DESCRIPTION OF THE DRAWINGS

Various exemplary embodiments of the present disclosure are described in detail below with reference to the following Figures. The drawings are provided for purposes of illustration only and merely depict exemplary embodiments of the present disclosure to facilitate the reader's understanding of the present disclosure. Therefore, the drawings should not be considered limiting of the breadth, scope, or applicability of the present disclosure. It should be noted that for clarity and ease of illustration these drawings are not necessarily drawn to scale.

FIG. 1A illustrates an exemplary wireless communication network, in accordance with some embodiments of the present disclosure.

FIG. 1B illustrates a block diagram of an exemplary wireless communication system, in accordance with some embodiments of the present disclosure.

FIG. 2 illustrates an exemplary architecture of an intelligent reflective surface for user equipment positioning, in accordance with some embodiments of the present disclosure.

FIG. 3 illustrates a signaling diagram between a base station and user equipment for performing a method for user equipment positioning, in accordance with some embodiments of the present disclosure.

FIG. 4A illustrates a signal reflection diagram of an intelligent reflection surface, in accordance with some embodiments of the present disclosure.

FIG. 4B illustrates an expanded view of a reconfigurable reflecting element in an intelligent reflection surface, in accordance with some embodiments of the present disclosure.

FIG. 4C illustrates an exemplary equivalent circuit of a positive-intrinsic-negative (PIN) diode, in accordance with some embodiments of the present disclosure.

FIG. 5A illustrates a positioning reference signal transmission timing diagram, in accordance with some embodiments of the present disclosure.

FIG. 5B illustrates an exemplary downlink positioning reference signal transmission architecture, in accordance with some embodiments of the present disclosure.

FIG. 6 illustrates an example method for performing user equipment positioning estimation, in accordance with some embodiments of the present disclosure.

### DETAILED DESCRIPTION OF EXEMPLARY EMBODIMENTS

Various exemplary embodiments of the present disclosure are described below with reference to the accompanying figures to enable a person of ordinary skill in the art to make and use the present disclosure. As would be apparent to those of ordinary skill in the art, after reading the present disclosure, various changes or modifications to the examples described herein can be made without departing from the scope of the present disclosure. Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

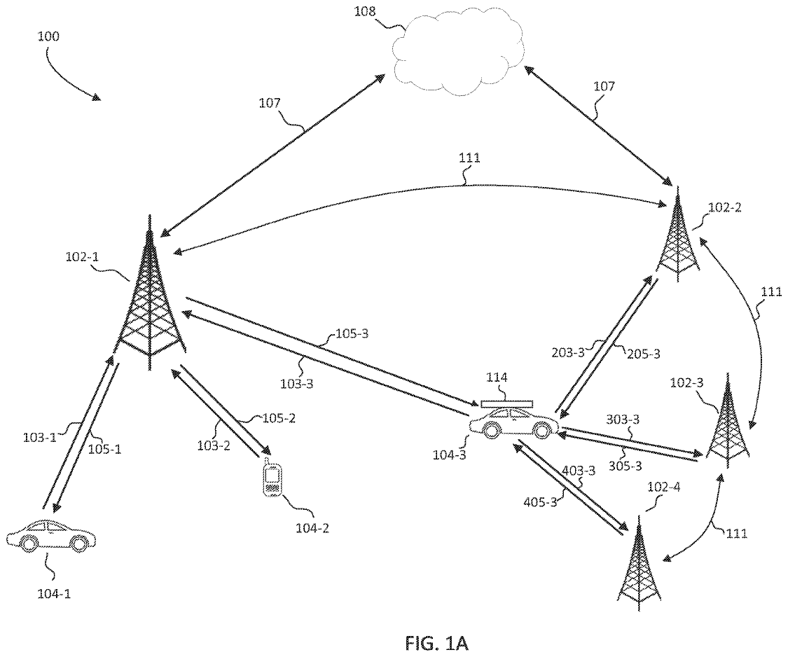

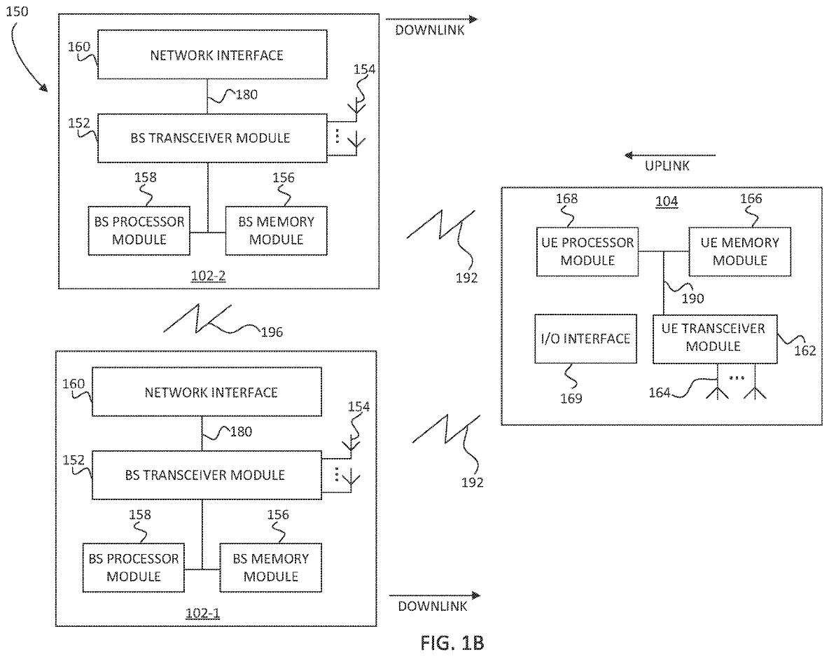

FIG. 1A illustrates an exemplary wireless communication network 100, in accordance with some embodiments of the present disclosure. In a wireless communication system, a network side communication node or a base station (BS) 102 can be a node B, an E-UTRA Node B (also known as Evolved Node B, eNodeB or eNB), a New Generation eNB (ng-eNB), a gNodeB (also known as gNB) in new radio (NR) technology, a pico station, a femto station, a relay, a transmission points (TRP), a road-side unit (RSU), or the like. A terminal side communication device or a user equipment (UE) 104 can be a long range communication system like a mobile phone, a smart phone, a personal digital assistant (PDA), tablet, laptop computer, or a short range communication system such as, for example a wearable device, a vehicle with a vehicular communication system and the like. A network communication node and a terminal side communication device are represented by a BS 102 and a UE 104, respectively, and in all the embodiments in this disclosure hereafter, and are generally referred to as “communication nodes” and “communication device” herein. Such communication nodes and communication devices may be capable of wireless and/or wired communications, in accordance with various embodiments of the invention. It is noted that all the embodiments are merely preferred examples, and are not intended to limit the present disclosure. Accordingly, it is understood that the system may include any desired combination of BSs 102 and UEs 104, while remaining within the scope of the present disclosure.

Referring to FIG. 1A, the wireless communication network 100 includes a first BS 102-1, a first UE 104-1, a second UE 104-2, and a third UE 104-3. In some embodiments, a plurality of UEs 104 may form direct communication (i.e., uplink) channels 103-1, 103-2, and 103-3 with the first BS 102. In some embodiments, the plurality of UEs 104 may also form direct communication (i.e., downlink) channels 105-1, 105-2, and 105-3 with the first BS 102-1. The direct communication channels between the plurality of UEs 104 and a distributed unit of the BS 102 can be through interfaces such as an Uu interface, which is also known as E-UTRAN air interface. In some other embodiments, the direct communication channels between the plurality of UEs 104 and the BS 102 is through 5G New Radio (NR) Radio Access Network (RAN). In some embodiments, the UE 104 comprises a plurality of transceivers which enables the UE 104 to support multi connectivity so as to receive data simultaneously from a plurality of BSs 102-1 to 102-4. Each of the plurality of BSs 102-1 to 102-4 may be connected to a core network (CN) 108 on a user plane (UP) through an external interface 107, e.g., an Iu interface, an NG-U interface, or an S1-U interface. In some embodiments, the CN 108 is one of the following: an Evolved Packet Core (EPC) and a 5G Core Network (5GC). In some embodiments, the CN 108 further comprises at least one of the following: Access and Mobility Management Function (AMF), Location Management Function (LMF), Location Management Server (LMS), User Plane Function (UPF), and System Management Function (SMF).

A direct communication channel 111 between any BSs in the plurality of BSs 102-1 to 102-4 may be implemented through an X2 interface or an Xn interface for NR communications. In some embodiments, the direct communication channel 111 between any BSs in the plurality of BSs 102-1 to 102-4 may be wired, optical or wireless. In some embodiments, a BS (gNB) is split into a Distributed Unit (DU) and a Central Unit (CU) on the UP, between which the direct communication is through a F1-U interface. In some embodiments, a CU of each of the plurality of BSs 102-1 to 102-4 can be further split into a Control Plane (CP) and a User Plane (UP), between which the direct communication is through an E1 interface. Hereinafter in the present disclosure, an Xx interface is used to describe one of the following interfaces, the NG interface, the SI interface, the X2 interface, the Xn interface, the F1 interface, and the E1 interface. When an Xx interface is established between two nodes, the two nodes can transmit control signaling on the CP and/or data on the UP.

In some embodiments, one of the plurality of UEs 104, such as the UE 104-3 may form direct communication (i.e., uplink) channels 103-3, 203-3, 303-3 and 403-3 with the plurality of BSs 102-1 to 102-4, and the UE 104-3 may also form direct communication (i.e., downlink) channels 105-3, 205-3, 305-3 and 405-3 with the plurality of BSs 102-1 to 102-4. In some embodiments, the UE 104-3 may comprise an Intelligent Reflecting Surface (IRS) 114 attached to the main body of the UE 104-3. The IRS 114 may be referred to as a planar surface comprising a plurality of small, reconfigurable reflecting elements, each of which can induce a controllable amplitude, phase and/or polarization change to the incident signal independently, without any need of baseband processing. In one embodiment, the UE 104-3 is a vehicle, and the IRS 114 may be installed on the roof of the UE 104-3. In another embodiment, the IRS 114 is installed on mobile robots of the UE 104-3. In yet another embodiment, the UE 104-3 is an uncrewed aerial vehicle (UAV) and the IRS 114 is placed facing the ground. In still another embodiment, the UE 104-3 is a handheld device, and the IRS 114 is installed on the UE 104-3. In some embodiments, the UE 104-3 is connected to the IRS 114 through a wire while the UE 104-3 and the IRS 114 are located at different locations. In some other embodiments, the UE 104-3 and the IRS 114 are located at different locations, and the UE 104-3 is connected to the IRS 114 through a wireless communication channel using antennas installed on both the UE 104-3 and the IRS 114. In one embodiment, the IRS 114 is configured to reflect incident signals transmitted from at least one of the plurality of BSs 102-1 to 102-4 for positioning estimation of the UE 104-3, while the UE 104-3 and the IRS 114 are located at different locations. In this embodiment, the UE 104-3 may be configured to transmit a UE message (e.g. UE capability message) to the at least one of the plurality of BSs 102-1 to 102-4, wherein the UE message comprises the location of the IRS 114 (e.g. distance and direction) relative to the UE 104-3. In this way, the at least one of the plurality of BSs 102-1 to 102-4 may determine the exact location of the IRS 114 using the location of the IRS 114 relative to the UE 104-3 and the exact location of the UE 104-3. In another embodiment, the exact location of the IRS 114 is predetermined and transmitted to the at least one of the plurality of BSs 102-1 to 102-4 through the UE message. In yet another embodiment, the exact location of the IRS 114 is predetermined and stored in the at least one of the plurality of BSs 102-1 to 102-4.

In some embodiments, at least one BS from the plurality of BSs 102-1 to 102-4 is configured to generate incident signals to the UE 104-3, and the UE 104-3 may be configured to reflect the incident signals towards specific directions using the installed IRS 114. In some other embodiments, the at least one BS comprises information on the particular cell on which the UE 104-3 is camped, and the at least one BS assigns a specific wireless communication node and the corresponding transmit power to use for positioning reference signal (PRS) transmissions.

FIG. 1B illustrates a block diagram of an exemplary wireless communication system 150, in accordance with some embodiments of the present disclosure. The system 150 may include components and elements configured to support known or conventional operating features that need not be described in detail herein. In some embodiments, the system 150 can be used to transmit and receive data symbols in a wireless communication environment such as the wireless communication network 100 of FIG. 1A, as described above.

The system 150 generally includes a first BS 102-1, a second BS 102-2, and a UE 104, collectively referred to as BS 102 and UE 104 below for ease of discussion. The first BS 102-1 and the second BS 102-2 each comprises a BS transceiver module 152, a BS antenna array 154, a BS memory module 156, a BS processor module 158, and a network interface 160. In the illustrated embodiment, each module of the BS 102 is coupled and interconnected with one another as necessary via a data communication bus 180. The UE 104 comprises a UE transceiver module 162, a UE antenna 164, a UE memory module 166, a UE processor module 168, and an I/O interface 169. In the illustrated embodiment, each module of the UE 104 is coupled and interconnected with one another as necessary via a date communication bus 190. The BS 102 communicates with the UE 104 via a communication channel 192, which can be any wireless channel or other medium known in the art suitable for transmission of data as described herein.

As would be understood by persons of ordinary skill in the art, the system 150 may further include any number of modules other than the modules shown in FIG. 1B. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present invention.

A wireless transmission from a transmitting antenna of the UE 104 to a receiving antenna of the BS 102 is known as an uplink (UL) transmission, and a wireless transmission from a transmitting antenna of the BS 102 to a receiving antenna of the UE 104 is known as a downlink (DL) transmission. In accordance with some embodiments, the UE transceiver 162 may be referred to herein as an “uplink” transceiver 162 that includes a radio frequency (RF) transmitter and receiver circuitry that is each coupled to the UE antenna 164. A duplex switch (not shown) may alternatively couple the uplink transmitter or receiver to the uplink antenna in time duplex fashion. Similarly, in accordance with some embodiments, the BS transceiver 152 may be referred to herein as a “downlink” transceiver 152 that includes RF transmitter and receiver circuitry that are each coupled to the antenna array 154. A downlink duplex switch may alternatively couple the downlink transmitter or receiver to the downlink antenna array 154 in time duplex fashion. The operations of the two transceivers 152 and 162 are coordinated in time such that the uplink receiver is coupled to the uplink UE antenna 164 for reception of transmissions over the wireless communication channel 192 at the same time that the downlink transmitter is coupled to the downlink antenna array 154. Preferably, there is close synchronization timing with only a minimal guard time between changes in duplex direction. The UE transceiver 162 communicates through the UE antenna 164 with the BS 102 via the wireless communication channel 192. The BS transceiver 152 communications through the BS antenna 154 of a BS (e.g., the first BS 102-1) with the other BS (e.g., the second BS 102-2) via a wireless communication channel 196. The wireless communication channel 196 can be any wireless channel or other medium known in the art suitable for direct communication between BSs.

The UE transceiver 162 and the BS transceiver 152 are configured to communicate via the wireless data communication channel 192, and cooperate with a suitably configured RF antenna arrangement 154/164 that can support a particular wireless communication protocol and modulation scheme. In some exemplary embodiments, the UE transceiver 162 and the BS transceiver 152 are configured to support industry standards such as the Long Term Evolution (LTE) and emerging 5G standards (e.g., NR), and the like. It is understood, however, that the invention is not necessarily limited in application to a particular standard and associated protocols. Rather, the UE transceiver 162 and the BS transceiver 152 may be configured to support alternate, or additional, wireless data communication protocols, including future standards or variations thereof.

The processor modules 158 and 168 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 158 and 168, respectively, or in any practical combination thereof. The memory modules 156 and 166 may be realized as RAM memory, flash memory, ROM memory, EPROM memory, EEPROM memory, registers, a hard disk, a removable disk, a CD-ROM, or any other form of storage medium known in the art. In this regard, the memory modules 156 and 166 may be coupled to the processor modules 158 and 168, respectively, such that the processors modules 158 and 168 can read information from, and write information to, memory modules 156 and 166, respectively. The memory modules 156 and 166 may also be integrated into their respective processor modules 158 and 168. In some embodiments, the memory modules 156 and 166 may each include a cache memory for storing temporary variables or other intermediate information during execution of instructions to be executed by processor modules 158 and 168, respectively. The memory modules 156 and 166 may also each include non-volatile memory for storing instructions to be executed by the processor modules 158 and 168, respectively.

The network interface 160 generally represents the hardware, software, firmware, processing logic, and/or other components of the base station 102 that enable bi-directional communication between BS transceiver 152 and other network components and communication nodes configured to communication with the BS 102. For example, network interface 160 may be configured to support internet traffic. In a typical deployment, without limitation, network interface 160 provides an 802.3 Ethernet interface such that BS transceiver 152 can communicate with a conventional Ethernet based computer network. In this manner, the network interface 160 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 160 could allow the BS 102 to communicate with other BSs or a CN over a wired or wireless connection.

Referring again to FIG. 1A, as mentioned above, the BS 102 repeatedly broadcasts system information associated with the BS 102 to one or more UEs 104 so as to allow the UEs 104 to access the network within the cells where the BS 102 is located, and in general, to operate properly within the cell. Plural information such as, for example, downlink and uplink cell bandwidths, downlink and uplink configuration, cell information, configuration for random access, etc., can be included in the system information. Typically, the BS 102 broadcasts a first signal carrying some major system information, for example, configuration of the cell where the BS 102 is located through a Physical Broadcast Channel (PBCH). For purposes of clarity of illustration, such a broadcasted first signal is herein referred to as “first broadcast signal.” It is noted that the BS 102 may subsequently broadcast one or more signals carrying some other system information through respective channels (e.g., a Physical Downlink Shared Channel (PDSCH)).

Referring again to FIG. 1B, in some embodiments, the major system information carried by the first broadcast signal may be transmitted by the BS 102 in a symbol format via the communication channel 192 (e.g., a PBCH). In accordance with some embodiments, an original form of the major system information may be presented as one or more sequences of digital bits and the one or more sequences of digital bits may be processed through plural steps (e.g., coding, scrambling, modulation, mapping steps, etc.), all of which can be processed by the BS processor module 158, to become the first broadcast signal. Similarly, when the UE 104 receives the first broadcast signal (in the symbol format) using the UE transceiver 162, in accordance with some embodiments, the UE processor module 168 may perform plural steps (de-mapping, demodulation, decoding steps, etc.) to estimate the major system information such as, for example, bit locations, bit numbers, etc., of the bits of the major system information. The UE processor module 168 is also coupled to the I/O interface 169, which provides the UE 104 with the ability to connect to other devices such as computers. The I/O interface 169 is the communication path between these accessories and the UE processor module 168.

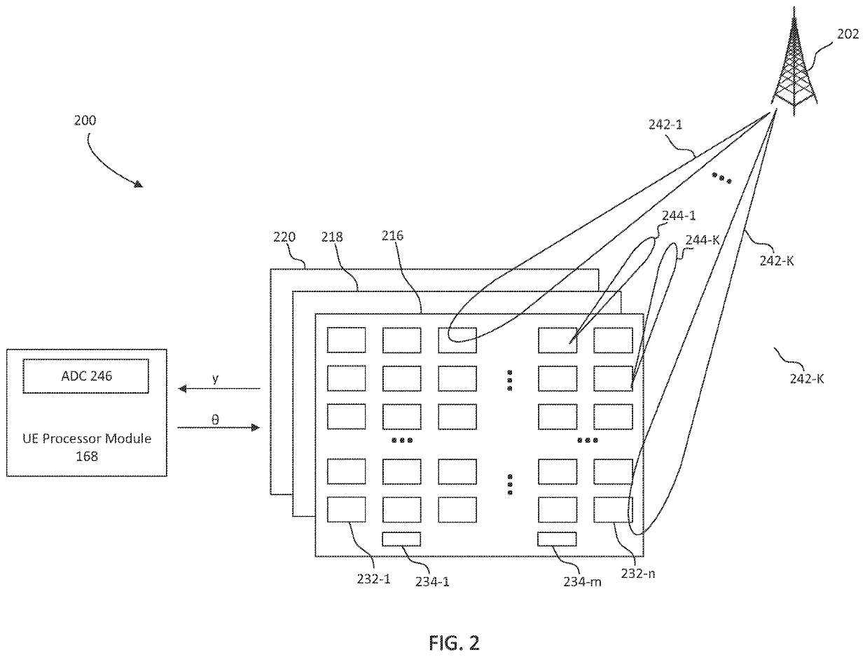

FIG. 2 illustrates an exemplary architecture of an IRS for UE positioning, in accordance with some embodiments of the present disclosure. In some embodiments, the IRS 114 as shown in FIG. 1A may be in communication with a BS 202 for UE positioning estimation of the UE 104-3, wherein the IRS 114 comprises a first/outside layer 216, a second/intermediate layer 218 and a third/inside layer 220.

In some embodiments, the first/outside layer 216 comprises a plurality of reconfigurable reflecting elements 232-1 to 232-n. In one embodiment, each of the plurality of reconfigurable reflecting elements 232-1 to 232-n comprises a respective metallic patch printed on a dielectric substrate, and each of the respective metallic patches can be configured to manipulate incident signals. In some other embodiments, the second/intermediate layer 218 comprises a copper plate used to reduce signal energy leakage during IRS's reflection. In yet some other embodiments, the third/inside layer 220 comprises a control circuit board, wherein the control circuit board can be configured to activate the plurality of reconfigurable reflecting elements 232-1 to 232-n. In some embodiments, the control circuit board in the third/inside layer 220 is configured to tune the reflection amplitude and/or phase shifts in each of the reconfigurable reflecting elements 232-1 to 232-n at real time. In some embodiments, the UE processor module 168 shown in FIG. 1B may be coupled to the IRS 114 for controlling operations in the control circuit board in the third/inside layer 220. In one embodiment, the UE processor module 168 acts as a gateway to communicate with other network components in the network through wired or wireless backhaul/control links.

In some embodiments, a plurality of sensors 234-1 to 234-m can be deployed in the first/outside layer 216 to enhance the environmental learning capability of the IRS 114. In one embodiment, each of the plurality of reconfigurable reflecting elements 232-1 to 232-n is associated with a respective sensor from the plurality of sensors 234-1 to 234-m. In another embodiment, the plurality of sensors 234-1 to 234-m is interlaced with the plurality of reconfigurable reflecting elements 232-1 to 232-n in the first/outside layer 216. In yet another embodiment, each of the plurality of sensors 234-1 to 234-m is configured to sense the surrounding radio signals of interest to facilitate the UE Processor Module in designing the reflection coefficient for the respective one of the plurality of reconfigurable reflecting elements 232-1 to 232-n.

In some embodiments, the plurality of sensors 234-1 to 234-m is configured to receive incident signals from the BS 202. Upon receiving the incident signals from the BS 202, the plurality of sensors 234-1 to 234-m may be configured to down convert the received incident signals into analog signals using frequency translation to shift the original radio frequency (RF) incident signals to analog signals of lower frequency. In some embodiments, signal filtering and amplification can also be performed in the down-conversion process.

Once the incident signals are down converted into analog signals, as shown by the analog signal y in FIG. 2, the analog signal y may be transmitted from the IRS 114 to the UE processor module 168, wherein the UE processor module 168 comprises a down-conversion and an analog-to-digital convertor (ADC) 246 to convert the analog signal y to corresponding digital baseband signals for digital baseband processing. Using the digital baseband signals from the output of the ADC 246, the UE processor module 168 may be configured to estimate the angle of arrival (AoA) of the received incident signals from the BS 202, as well as the distance between the IRS 114 and the transmitting node BS 202. Examples of algorithms that can be applied to estimate the AoA of the received incident signals from the BS 202 and the distance between the IRS 114 and the transmitting node BS 202 include Capon's Minimum Variance, MUltiple SIgnal Classification (MUSIC), Estimation of Signal Parameters via Rotational Invariance Techniques (ESPRIT), and Matrix-Pencil method. In this way, UE positioning estimation can be performed by receiving reference signals from a single transmitting point, as shown by the single BS 202 in FIG. 2.

Relative to conventional positioning methods, one of the most significant advantages with the exemplary architecture of IRS for UE positioning shown in FIG. 2 is the energy savings and reduced signaling overhead. Upon receiving reference incident signals from the BS 202, the UE 104 comprising the UE processor module 168 is not required to transmit positioning measurement reports back to the serving BS 202. Instead, the IRS 114 comprising the plurality of reconfigurable reflecting elements 232-1 to 232-n is configured to reflect incident signals transmitted from the BS 202 for UE positioning estimation. Since no data transmissions are needed at the UE 104 during the incident signal reflection, the UE 104 does not establish a connection with the serving BS 202 during the IRS reflection procedure. This allows the UE 104 not to be in the CONNECTED state during the positioning process. In some embodiments, a new POSITIONING state may be used during the IRS reflection procedure, wherein the UE 104 is in a listen-only or reflection-only mode in the new POSITIONING state.

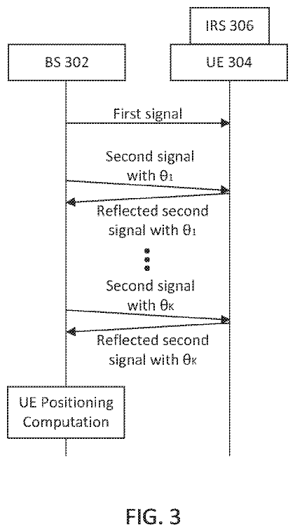

FIG. 3 illustrates a signaling diagram between a BS 302 and a UE 304 for performing a method for UE positioning, in accordance with some embodiments. In some embodiment, an IRS 306 is coupled to the UE 304 to reflect incident signals transmitted from the BS 302 for UE positioning estimation. In some embodiments, the BS 302 may receive a measurement initiation request from a location management server (LMS), wherein the measurement initiation request may be a new radio (NR) Reference Signal Received Power (RSRP) measurement initiation request, an NR Reference Signal Received Quality (RSRQ) measurement initiation request, an Enhanced Cell Identity (E-CID) measurement initiation request message, an Evolved Universal Terrestrial Radio Access Network Reference Signal Received Power (E-UTRA RSRP) measurement initiation request message, Evolved Universal Terrestrial Radio Access Network Reference Signal Received Quality (E-UTRA RSRQ) measurement initiation request message, or an Observed Time Difference Of Arrival (OTDOA) measurement initiation request message. In some embodiments, the measurement initiation request may indicate a request for UE positioning based on IRS. In some other embodiments, to optimize beam management, the BS 302 may request the LMS to initiate a UE positioning calculation procedure for the UE 304.

In some embodiments, the measurement initiation request comprises downlink positioning reference signal (DL-PRS) configurations, wherein the DL-PRS configurations comprise at least one of: positioning reference signal (PRS) resources, muting resources, PRS pattern and periodicity, and a list of measurements to be reported back to the core network, wherein the list of measurements comprises at least one of: a Round-Trip-Delay (RTD), a Time-of-Arrival (ToA), a Received Signal Received Power (RSRP), an Angle-of-Arrival (AoA), and an Angle-of-Departure (AoD) of the PRS transmission. In some other embodiment, the DL-PRS configurations are pre-configured in the BS 302. In yet some another embodiments, the DL-PRS configurations are pre-configured in the UE 304, and the UE 304 is pre-configured to reflect incident signals from the BS 302 towards the same direction as the incident signals.

In some embodiments, upon receiving the measurement initiation request, the BS 302 may transmit a first signal to the UE 304 for performing UE positioning. In some embodiments, the first signal comprises an indication to instruct the UE 304 to receive and reflect DL-PRS back towards the corresponding transmitting node that sends the DL-PRS. In some embodiments, the indication instructs the UE 304 to reflect the DL-PRS back to the corresponding transmitting node using the IRS 306. In some other embodiments, the indication instructs the UE 304 to reflect the DL-PRS back to the corresponding transmitting node in the same direction of the incident DL-PRS.

In some embodiments, the first signal sent from the BS 302 to the UE 304 may be transmitted through system information block (SIB) signaling, radio resource control (RRC) signaling, medium access control-control element (MAC-CE) signaling, or downlink control information (DCI) signaling. In some other embodiments, the indication for instructing the UE 304 to reflect the DL-PRS may be pre-configured in the UE 304 or sent to the UE 304 from the BS 302 via a paging message. In one embodiment, the first signal is transmitted through an SIB Type 1 (SIB1) signaling message, wherein the SIB1 signaling message is periodically transmitted from the BS 302 to the UE 304, such that the SIB1 signaling message can be transmitted to the UE 304 even when the UE 304 is still in IDLE or INACTIVE state.

After transmitting the first signal to the UE 304, the BS 302 may be configured to transmit a plurality of second signals to the UE 304. In some embodiments, each of the plurality of second signals comprises a respective DL-PRS with a respective AoA for performing UE positioning for the UE 304, wherein the respective DL-PRS comprises resource allocation information for downlink transmission, modulation and coding schemes, and pilot/reference signals for UE positioning measurements. Upon receiving each of the plurality of second signals, the UE 304 may be configured to measure the respective AoA (e.g. θ₁, . . . , θₖ as shown in FIG. 3) for each of the plurality of second signals using the plurality of sensors 234-1 to 234-m and the method described above with reference to FIG. 2.

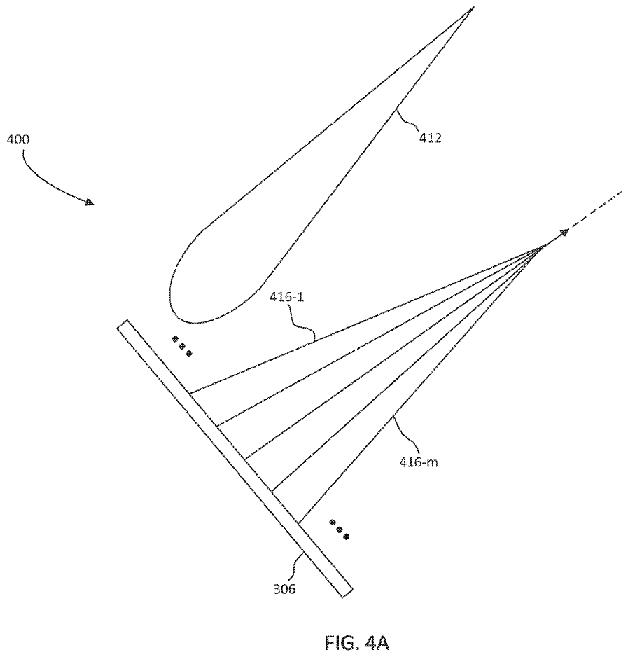

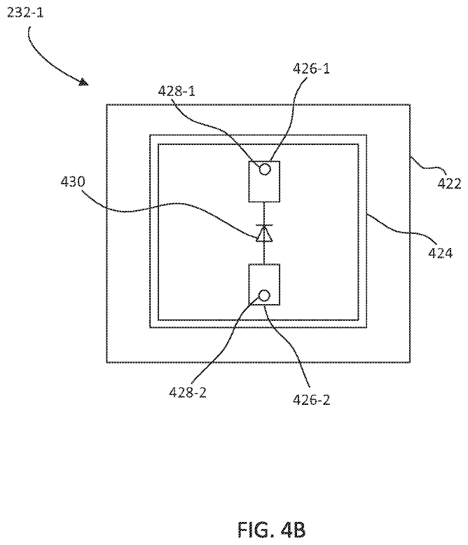

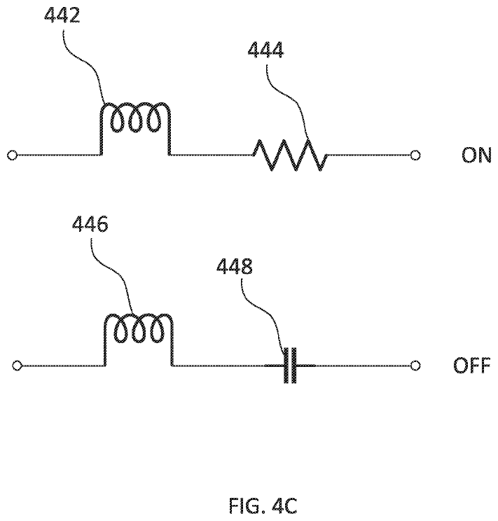

In some embodiments, once the respective AoA for each of the plurality of second signals is measured, the IRS 306 may be configured to reflect each of the plurality of second signals back towards the transmitting node BS 302 with the same direction as measured in the respective AoA for each of the plurality of second signals. In one embodiment, the IRS 306 comprises the plurality of reconfigurable reflecting elements 232-1 to 232-n and the plurality of sensors 234-1 to 234-m, and the plurality of reconfigurable reflecting elements 232-1 to 232-n is coordinated to reflect each of the plurality of second signals back towards the BS 302 with the same direction as measured in the AoA for each of the plurality of second signals. In another embodiment, the plurality of reconfigurable reflecting elements 232-1 to 232-n is coordinated to focus each of the reflected second signals such that the DL-PRS transmitting node BS 302 receives the reflected second signals at sufficient receive strength. As illustrated in a signal reflection diagram 400 in FIG. 4A, upon receiving a second signal 412, each of the plurality of reconfigurable reflecting elements 232-1 to 232-n in the IRS 306 may be configured to reflect the second signal 412 to produce a respective one of a plurality reflected second signals 416-1 to 416-m. In some embodiments, for the second signal 412 received at the IRS 306, a respective AoA at each of the plurality of reconfigurable reflecting elements 232-1 to 232-n is slightly different due to slight different locations of each of the plurality of reconfigurable reflecting elements 232-1 to 232-n. In such a case, the amplitude and/or phase shifts in each of the plurality of reconfigurable reflecting elements 232-1 to 232-n may be jointly adjusted such that each of the plurality of reconfigurable reflecting elements 232-1 to 232-n reflects the second signal at its respective AoA to form a beam that reaches the destination node with the maximum achievable power. In some embodiments, each of the plurality of reconfigurable reflecting elements 232-1 to 232-n reflects the second signal 412 to generate a respective one of a plurality of reflected second signals 416-1 to 416-m, such that the plurality of reflected second signals 416-1 to 416-m is focused towards the transmission node BS 302. In some embodiments, the plurality of reflected second signals 416-1 to 416-m forms a beam that reaches the destination node with the maximum achievable power. In some embodiments, the power value of the beam formed by the plurality reflected second signals 416-1 to 416-m is larger than the corresponding power value in each of the plurality reflected second signals 416-1 to 416-m.

In one embodiment, the plurality of reconfigurable reflecting elements 232-1 to 232-n is adjusted by mechanical actuation via mechanical rotation to control the directions of the plurality reflected second signals 416-1 to 416-m. In another embodiment, the plurality of reconfigurable reflecting elements 232-1 to 232-n is adjusted by functional materials such as liquid crystal or graphene. In yet another embodiment, the plurality of reconfigurable reflecting elements 232-1 to 232-n is adjusted by electronic devices such as positive-intrinsic-negative (PIN) diodes, field-effect transistors (FETs), or micro-electromechanical system (MEMS) switches. The electronic devices used for controlling reflection of incident signals may provide fast response time, low reflection loss as well as relatively low energy consumption and hardware cost.

FIG. 4B illustrates an expanded view of the reconfigurable reflecting element 232-1 in the IRS 306, in accordance with some embodiments of the present disclosure. In some embodiments, the reconfigurable reflecting element 232-1 comprises a substrate 422, a protective outer metal layer 424, a pair of metal pieces 426-1 and 426-2 connected to two terminals of a PIN diode 430. In some embodiments, each of the pair of metal pieces 426-1 and 426-2 comprises a respective direct-current (DC) feeding via hole 428-1 and 428-2, respectively. In one embodiment, external voltages can be applied to the pair of metal pieces 426-1 and 426-2 using two external probes that are inserted into the via holes 428-1 and 428-2, respectively. By applying different voltage values at the metal pieces 426-1 and 426-2, the PIN diode 430 can be biased to switch between either an “ON” state or an “OFF” state.

FIG. 4C illustrates an exemplary equivalent circuit of the PIN diode 430 when biased to the “ON” state or to the “OFF” state, respectively. In one embodiment, the equivalent circuit of the PIN diode 430 in the “ON” state may be an inductor 442 and a resistor 444 in series as shown. In another embodiment, the equivalent circuit of the PIN diode 430 in the “OFF” state may be an inductor 446 and a capacitor 448 in series as shown. Based on different bias voltage values applied at the two terminals of the PIN diode 430, the PIN diode 430 may exhibit different equivalent circuits as shown in FIG. 4C, and the equivalent values of the components in the equivalent circuits shown in FIG. 4C (e.g. the values of the inductors 442 and 446, the resistor 444 and the capacitor 448) may also change based on the different applied biased voltages at the two terminals of the PIN diode 430.

In some embodiments, different values in the components of the equivalent circuits as shown in FIG. 4C may result in different phase-shift values as compared to the incident signal transmitted to the reconfigurable reflecting element 232-1. As a result, the direction of the reflected signal from the incident signal can be controlled by applying different bias voltage values at the two terminals of the PIN diode 430. In this way, the phase shifts in each of the plurality of reconfigurable reflecting elements 232-1 to 232-n can be jointly tuned such that the plurality reflected second signals 416-1 to 416-m forms a beam that reaches the destination node with the maximum power. In one embodiment, the different bias voltage values for the PIN diode 430 are sent from the UE Processor Module 168 to the reconfigurable reflecting element 232-1. In another embodiment, the different bias voltage values for the PIN diode 430 are sent from an IRS controller to the reconfigurable reflecting element 232-1. In some embodiments, the switching frequency of the PIN diode 430 may be up to 5 megahertz (MHz), which corresponds to the switching time of 0.2 microsecond (μs). This switching time of 0.2 microsecond is much smaller than a typical channel coherence time that is on the order of millisecond (ms) and thus well suited for mobile applications with time-varying channels.

In some embodiments, besides tuning the phase shift, the reflection amplitude of the reconfigurable reflecting element 232-1 can be also tuned. This additional control of the reflection amplitude may provide more flexibility in reshaping the reflected signal to achieve various communication objectives effectively. This may also offer a flexible way to trade-off between the hardware cost and reflection performance in practice, as amplitude control is generally of lower cost to implement as compared to phase control. In one embodiment, amplitude adjustment of the reconfigurable reflecting element 232-1 is performed by adjusting the load resistance/impedance in the reconfigurable reflecting element 232-1. For example, by changing the resistance of the reconfigurable reflecting element 232-1, a certain portion of the incident signal energy may be dissipated as heat, thus achieving a dynamic range of the reflection amplitude in [0, 1].

In some embodiments, the UE 304 is configured to apply a best beam-pair procedure for enhancing signal strength of the received second signal. In one embodiment, the second signal is transmitted from the BS 302 to the UE 304, wherein the BS 302 and the UE 304 are configured to perform a transmit beam sweep and a receive beam sweep, respectively. In one embodiment, the UE 304 is configured to perform the receive-beam sweep, and the beam-pair combination with the strongest RSRP measured at the UE 304 may be considered as the best beam-pair. Similarly, instead of using multiple-input and multiple-output (MIMO) antenna array to perform the receive beam sweep, the IRS 306 can be used to perform the receive beam sweep.

Referring back to FIG. 3, upon receiving each of the reflected second signals, the BS 302 may be configured to determine the AoA for each of the reflected second signals and the distance between the BS 302 and the IRS 306 for UE positioning computation using one of the following methods: Capon's Minimum Variance method, MUSIC method, ESPRIT method, and Matrix-Pencil method.

In some embodiments, each of the plurality of second signals sent from the BS 302 to the UE 304 comprises a respective train of DL-PRS pulses, wherein all the DL-PRS pulses from the same respective train are sent to the UE 304 with the same respective AoA. In one embodiment, each respective train of DL-PRS pulses comprises a respective first portion of DL-PRS pulses and a respective second portion of DL-PRS pulses, wherein the respective first portion of DL-PRS pulses is used by the UE 304 to determine the respective AoA, and the respective second portion of DL-PRS pulses is used by the UE 304 to reflect the second portion of DL-PRS pulses back to the BS 302 using the respective AoA determined by the respective first portion of DL-PRS pulses.

In some embodiments, the first signal transmitted from the BS 302 to the UE 304 may comprise a configuration message, wherein the configuration message comprises a respective pulse-width, a respective inter-pulse period (IPP) and a respective pulse repetition rate (PRR) for each of the plurality of second signals. In some embodiments, the UE 304 is configured to measure the timing of the pulse-reflection for each of the reflected second signals for UE positioning computation. In some other embodiments, the plurality of second signals comprises pulses with a PPR below a predetermined PPR threshold value. In such a case, the plurality of second signals is used for UE positioning estimation when the UE 304 moves in a speed below a predetermined speed threshold value or when the UE 304 is stationary. In this case, the Doppler shift and the velocity of the UE are not of interest. In yet some other embodiments, the plurality of second signals comprises pulses with a PPR value above the predetermined PPR threshold value. In such a case, the plurality of second signals is used for measuring the velocity of the UE 304 when the UE 304 moves in a speed above the predetermined speed threshold value, wherein the velocity of the UE 304 is taken into account for UE positioning estimation.

In some embodiments, upon receiving the reflected second signals, the BS 302 may be configured to perform a plurality of UE positioning measurements on the reflected second signals. In some embodiments, the plurality of UE positioning measurements comprises at least one of: a Round-Trip Delay (RTD), a Reference Signal Received Power (RSRP), and an Angle of Arrival (AoA). In some embodiments, the BS 302 performs UE positioning computation based on the plurality of UE positioning measurements. In some other embodiments, the BS 302 transmits the plurality of UE positioning measurements to the LMS, which is then configured to perform UE positioning computation based on the plurality of UE positioning measurements. In some embodiments, the BS 302 transmits a UE measurement report to the LMS, wherein the UE measurement report comprises at least one of the following: a respective BS identification (e.g. a gNB ID), a respective physical cell identity (PCI), and a respective NR Cell Global Identity (NCGI) for each of a plurality of BSs.

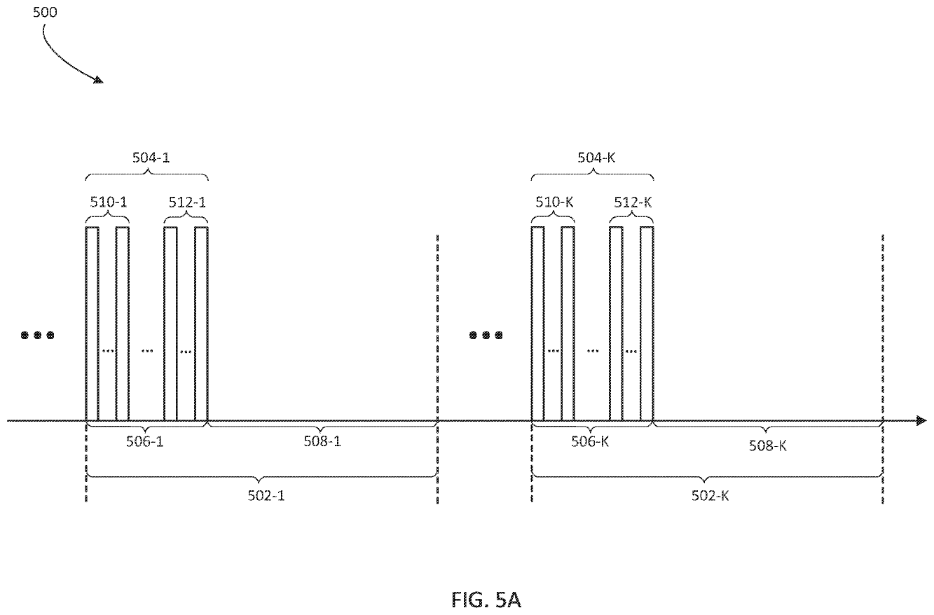

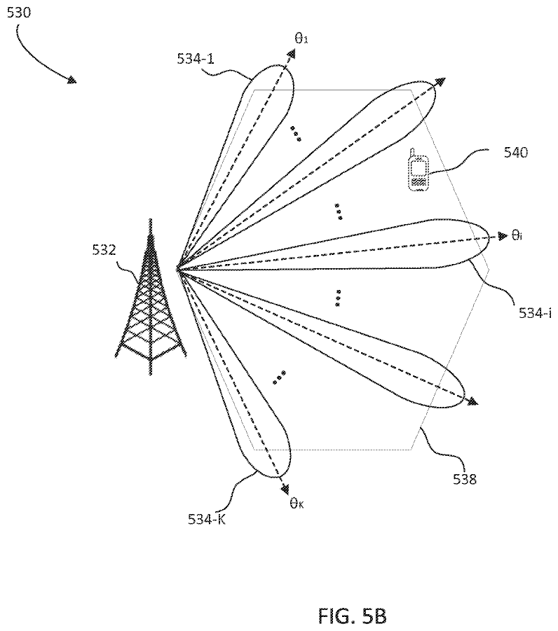

FIG. 5A illustrates a positioning reference signal (PRS) transmission timing diagram 500, in accordance with some embodiments of the present disclosure. The horizontal axis in FIG. 5A represents the time during the PRS transmission. In some embodiments, the BS 302 transmits the plurality of second signals to the UE 304 coupled to the IRS 306 as shown in FIG. 3, wherein each of the plurality of second signals is transmitted in a respective transmission duration from a plurality of transmission durations 502-1 to 502-K shown in FIG. 5A. In some embodiments, in each of the plurality of transmission durations 502-1 to 502-K, the BS 302 transmits a respective train of DL-PRS pulses to the UE 304, as shown by the respective train from a plurality of trains of DL-PRS pulses 504-1 to 504-K in each of the plurality of transmission durations 502-1 to 502-K.

In one embodiment, all the DL-PRS pulses in each of the plurality of trains of DL-PRS pulses 504-1 to 504-K are sent to the UE 304 with a same respective AoA. In another embodiment, each of the plurality of transmission durations 502-1 to 502-K comprises a respective first portion 506 and a respective second portion 508, wherein the respective train of DL-PRS pulses 504 is transmitted from the BS 302 to the UE 304 during the respective first portion 506, and the respective train of DL-PRS pulses 504 or a portion of the respective train of DL-PRS pulses 504 is reflected back from the IRS 306 coupled to the UE 304 to the BS 302 during the respective second portion 508. For example, in the transmission duration 502-1, the BS 302 may be configured to transmit the train of DL-PRS pulses 504-1 to the UE 304 coupled to the IRS 306 during the first portion 506-1, and the train of DL-PRS pulses 504-1 or a portion of the train of DL-PRS pulses 504-1 is reflected back to the BS 302 from the IRS 306 during the second portion 508-1 while the BS 302 is muted during the second portion 508-1. In one embodiment, the respective first portion 506 is larger than the respective second portion 508. In another embodiment, the respective first portion 506 is smaller than the respective second portion 508. In still another embodiment, the respective first portion 506 and the respective second portion 508 have equal time duration. In some embodiments, the duration of the first portion 506-1 is much shorter than that of the second portion 508-1. For example, in case of OFDM in 5G NR, the duration of the first portion 506-1 may be 0.067 seconds, and the duration of the second portion 508-1 can be a multiple (e.g. twice to twenty times) of the duration of the first portion 506-1 that takes into account the farthest distance from the UE 304 to the BS.

In some embodiments, the BS 302 and all other neighboring BSs are muted during the second portion 508, and the process illustrated in FIG. 3 may be repeated for all other neighboring BSs for UE positioning computation. In some embodiments, all other neighboring BSs are in a listen-only mode while being muted. That is, the process illustrated in FIG. 3 may be repeated in a way that a respective one of a plurality of BSs transmits a respective plurality of second signals to the UE 304 in turn while all other BSs from the plurality of BSs are muted, and the respective one of the plurality of BSs is also muted during the respective second portion of the respective transmission duration. In this way, multi-node interference during the PRS transmission can be reduced by muting BSs that are not actually transmitting the PRS. Moreover, muting BSs not actually transmitting the PRS can reduce unnecessary power consumption during the PRS transmission.

In some embodiments, each of the plurality of trains of DL-PRS pulses 504-1 to 504-K comprises one of the following: a partial symbol (i.e. a portion of a symbol) of a respective PRS, a symbol of a respective PRS, and a plurality of successive symbols of a respective PRS. That is, the first portion may be a partial symbol duration, a symbol duration, or a duration of a plurality of successive symbols. In some embodiments, the beam width for each of the plurality of trains of DL-PRS pulses 504-1 to 504-K is determined based on at least one of the following: the number of transmit antennas on the BS 302, the required positioning accuracy for UE positioning, the transmit power and the surface area of the IRS 306. In some embodiments, the symbol in each of the plurality of trains of DL-PRS pulses 504-1 to 504-K comprises a short-fixed pre-determined duration such as an OFDM symbol time.

In some embodiments, to cover the entire serving area of the BS 302, a total number of K directions corresponding to the plurality of trains of DL-PRS pulses 504-1 to 504-K is required, wherein the total number of K directions is determined by the beam width for each of the plurality of trains of DL-PRS pulses 504-1 to 504-K. As illustrated in an exemplary DL-PRS transmission architecture 530 in FIG. 5B, a BS 532 may be configured to transmit a plurality of second signals 534-1 to 534-K in order to cover an entire serving area 538 of the BS 532, wherein each of the plurality of second signals 534-1 to 534-K is transmitted at a respective AoA to a UE 540, as shown by the plurality of AoAs θ₁, . . . , θₖ in FIG. 5B. In some embodiments, the DL-PRS pulses can cover the entire serving area 538.

However, in some embodiments, the DL-PRS may not be transmitted every time to cover the entire serving area 538. In some cases, a set of DL-PRS pulses are transmitted in a specific direction. For example, if the network has a general idea where the UE 540 is located, the BS can transmit only in that general direction to cover only a portion of the serving area 538.

Referring back to FIG. 5A, in some embodiments, each of the plurality of trains of DL-PRS pulses 504-1 to 504-K may be partitioned into a respective first subset 510 and a respective second subset 512. For example, the train of DL-PRS pulses 504-1 may comprise a total number of N pulses, and the train of DL-PRS pulses 504-1 can be partitioned into a first subset 510-1 comprising m pulses and a second subset 512-1 comprising N-m pulses. Similarly, the train of DL-PRS pulses 504-K may comprise a total number of N pulses, and the train of DL-PRS pulses 504-K can be partitioned into a first subset 510-K comprising m pulses and a second subset 512-K comprising N-m pulses. In some embodiments, each of a plurality of first subsets 510-1 to 510-K is used by the UE 304 to determine a respective AoA of a respective second signal, and the corresponding each of a plurality of second subsets 512-1 to 512-K is then reflected by the IRS 306 in the direction of the respective AoA determined by the respective one of the plurality of first subsets 510-1 to 510-K.

In some embodiment, each of the plurality of first subsets 510-1 to 510-K and the respective one of the plurality of second subsets 512-1 to 512-K may have different pulse-width, IPP and PRR values. In some other embodiments, each of the plurality of first subsets 510-1 to 510-K and the respective one of the plurality of second subsets 512-1 to 512-K may have the same pulse-width, IPP and PRR values. In yet some other embodiments, the IPP value for each of the plurality of second subsets 512-1 to 512-K may be determined based on the farthest IRS-UE to be detected from the BS 302.

In some embodiments, the BS 532 is in communication with a plurality of UEs comprising the UE 540, and the BS 532 may be configured to schedule a respective timeslot for the positioning session of each of the plurality of UEs. In one embodiment, each of the plurality of UEs comprises a respective IRS for UE positioning estimation, and scheduling allows all the remaining UEs to turn off their respective IRSs while one specific UE reflects the DL-PRS transmissions. In some embodiments, the BS 532 is configured to assign a non-overlapping timeslots for the positioning session of each of the plurality of UEs. The timeslot assignment to a unique target UE from the plurality of UEs at a time also helps the neighboring BSs identify the target UE when they receive the reflected signals.

In some embodiments, after receiving the DL-PRS from the BS 532, each of the plurality of UEs can be configured to use programmable IRS technology to reflect the DL-PRS by modulating a known UE-specific unique code (e.g., a short UE Identification (ID)) onto the respective reflected signal. In some embodiments, the UE ID modulated is predefined and/or assigned by the network. This technique allows to locate multiple IRS-UEs in the same directional PRS beam. To receive and identify IRS-UEs at different distances in the same directional beam, the IPP of each of the plurality of second subsets 512-1 to 512-K may be set for a longer duration compared to the IPP of the respective one of the plurality of first subsets 510-1 to 510-K. In one embodiment, to avoid collisions of the reflected signals at the node receiver, each of the plurality of UEs can randomly select the incident PRS pulses for reflection. In another embodiment, the plurality of UEs may coordinate with each other such that each of the plurality of UEs can use UE-specific incident PRS pulses for reflection to avoid collisions. In such a case, the QPSK-modulation on the transmitted DL-PRS by the BS 532 may be optional. In some other embodiments, the neighboring BSs of the BS 532 are informed by the network allowing them to differentiate the target UE's reflected signals from other non-target UE's reflected signals and other random reflections.

In one embodiment, the respective reflected signal may be modulated by adjusting the ON/OFF state of each of the plurality of reconfigurable reflecting elements in the respective IRS of the respective UE from the plurality of UEs. In another embodiment, the ON/OFF state of a portion of reconfigurable reflecting elements in the respective IRS of the respective UE from the plurality of UEs is adjusted to modulate the respective reflected signal. In yet another example, for modulating the respective reflected signal, a passive beamforming is performed by adjusting the phase on the portion of the ON state for each of the plurality of reconfigurable reflecting elements in the respective IRS of the respective UE from the plurality of UEs. In still another embodiment, the passive beamforming is performed by adjusting the phase on the portion of the ON state for only a portion of the plurality of reconfigurable reflecting elements in the respective IRS of the respective UE from the plurality of UEs.

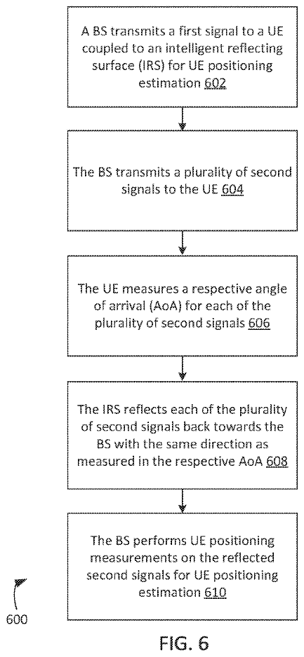

FIG. 6 illustrates an example method 600 for performing UE positioning estimation, in accordance with some embodiments. The operations of method 600 presented below are intended to be illustrative. In some embodiments, method 600 may be accomplished with one or more additional operations not described and/or without one or more of the operations discussed. Additionally, the order in which the operations of method 600 are illustrated in FIG. 6 and described below is not intended to be limiting.

At step 602, a BS transmits a first signal to a UE coupled to an IRS for UE positioning estimation. In some embodiments, the first signal comprises an indication to instruct the UE to receive DL-PRSs and reflect the DL-PRSs using the IRS back towards the BS. In some embodiments, the first signal may be transmitted through SIB signaling, RRC signaling, MAC-CE signaling, DCI signaling, or SIB1 signaling message, wherein the SIB1 signaling message is periodically transmitted from the BS to the UE, such that the SIB1 signaling message can be transmitted to the UE even when the UE is in IDLE or INACTIVE state.

At step 604, the BS transmits a plurality of second signals to the UE. In some embodiments, each of the plurality of second signals comprises a respective DL-PRS with a respective AoA at the UE for performing UE positioning, such that the plurality of second signals covers the entire serving area of the BS.

At step 606, the UE may be configured to measure the respective AoA (e.g. θ₁, . . . , θₖ as shown in FIG. 3 and FIG. 5B) for each of the plurality of second signals using a plurality of sensors on the IRS. In some embodiments, a UE processor module in the UE may be configured to estimate the AoA for each of the plurality of second signals using one of the following algorithms: Capon's Minimum Variance, MUSIC, ESPRIT, and Matrix-Pencil method.

At step 608, the IRS may be configured to reflect each of the plurality of second signals back towards the BS with the same direction as measured in the respective AoA for each of the plurality of second signals. In one embodiment, the IRS comprises a plurality of reconfigurable reflecting elements, which is coordinated to reflect each of the plurality of second signals back towards the BS with the same direction as measured in the AoA. In another embodiment, the plurality of reconfigurable reflecting elements is coordinated to focus the reflected second signals such that the BS receives the reflected second signals at sufficient receive strength.

At step 610, upon receiving the reflected second signals, the BS may be configured to determine the AoA for each of the reflected second signals and the distance between the BS and the IRS for UE positioning computation using one of the following methods: Capon's Minimum Variance method, MUSIC method, ESPRIT method, and Matrix-Pencil method. In some embodiments, the BS may be configured to perform a plurality of UE positioning measurements on the reflected second signals, wherein the plurality of UE positioning measurements comprises at least one of: an RTD, an RSRP, and an AoA. In some other embodiments, the BS performs UE positioning computation based on the plurality of UE positioning measurements. In yet some other embodiments, the BS transmits the plurality of UE positioning measurements to an LMS, which is then configured to perform UE positioning computation based on the plurality of UE positioning measurements.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof. Accordingly, as used herein, the terms “transmit” and any tenses thereof, refer to and encompass the sending or propagation of signals via any known wireless, wired or optical transmission mediums and techniques.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques.

To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, module, etc. can be configured to perform one or more of the functions described herein. The term “configured to” or “configured for” as used herein with respect to a specified operation or function refers to a processor, device, component, circuit, structure, machine, module, etc. that is physically constructed, programmed and/or arranged to perform the specified operation or function.

Furthermore, a person of ordinary skill in the art would understand that various illustrative logical blocks, modules, devices, components and circuits described herein can be implemented within or performed by one or more circuits or circuitry. As used herein, the term “circuitry” refers to and includes any one or more of the following: discrete circuit components or devices coupled to each other to form circuit, logic circuitry, integrated circuits, application specific integrated circuits, state machines, general purpose processors, special purpose processors, digital signal processors (DSP), microprocessors, field programmable gate arrays (FPGA) or other programmable logic devices, or any combination thereof. Circuitry can further include antennas, reflectors, transmitters, receivers and/or transceivers to communicate with various components, devices or nodes within a communication network. As used herein, the term “processor” refers to a combination of structures including processing circuitry, a memory coupled to the processing circuitry, and executable code stored in the memory that when executed by the processing circuitry perform the functions or operations instructed by the executable code.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, non-transitory computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A method comprising:
receiving, at a wireless communication device, a first signal and a plurality of second signals from a wireless communication node, wherein:
the first signal comprises an indication to instruct the wireless communication device to reflect each of the plurality of second signals back towards the wireless communication node using an Intelligent Reflecting Surface (IRS) coupled to the wireless communication device, and
the plurality of second signals covers at least part of a serving area of the wireless communication node; and
reflecting, at the wireless communication device, each of the plurality of second signals back towards the wireless communication node using the IRS for positioning computation of the wireless communication device.

2. The method of claim 1, wherein each of the plurality of second signals is received at a respective different Angle of Arrival (AoA) from a plurality of AoAs.

3. The method of claim 2, wherein each of the plurality of AoAs is measured at the wireless communication device using one of the following: Capon's Minimum Variance method, MUltiple Signal Classification (MUSIC) method, Estimation of Signal Parameters via Rotational Invariance Techniques (ESPRIT) method, and Matrix-Pencil method.

4. The method of claim 2, wherein the first signal comprises the indication to instruct the wireless communication device to reflect each of the plurality of second signals back towards the wireless communication node using the IRS with a respective same direction as measured in the respective one of the plurality of AoAs, wherein the indication is one of:
transmitted through system information block (SIB) signaling;
transmitted through SIB Type 1 (SIB1) signaling;
transmitted through radio resource control (RRC) signaling;
transmitted through medium access control-control element (MAC-CE) signaling;
transmitted through downlink control information (DCI) signaling;
transmitted via a paging message; or
pre-configured in the wireless communication device.

5. The method of claim 4, wherein a respective one of the plurality of second signals comprises a respective downlink-positioning reference signal (DL-PRS), wherein the respective DL-PRS comprises a respective train of DL-PRS pulses, wherein the respective train of DL-PRS pulses comprises a respective first subset of DL-PRS pulses and a respective second subset of DL-PRS pulses, wherein:
the respective first subset of DL-PRS pulses is used to determine the respective AoA of the respective one of the plurality of second signals; and
the respective second subset of DL-PRS pulses is reflected by the IRS towards the wireless communication node with the respective same direction as measured in the respective AoA of the respective one of the plurality of second signals.

6. The method of claim 1, wherein the wireless communication device is in a POSITIONING state when each of the plurality of second signals is reflected back towards the wireless communication node, wherein the wireless communication device is in a listen-only mode in the POSITIONING state.

7. A wireless communication device comprising:
a receiver configured to receive a first signal and a plurality of second signals from a wireless communication node, wherein:
the first signal comprises an indication to instruct the wireless communication device to reflect each of the plurality of second signals back towards the wireless communication node using an Intelligent Reflecting Surface (IRS) coupled to the wireless communication device, and
the plurality of second signals covers at least part of a serving area of the wireless communication node; and
a transceiver configured to reflect each of the plurality of second signals back towards the wireless communication node using the IRS for positioning computation of the wireless communication device.

8. A non-transitory computer readable medium storing computer-executable instructions which when executed cause the wireless communication device to perform the method of claim 1.

9. Circuitry configured to cause the wireless communication device to perform the method of claim 1:

10. A method comprising:
transmitting, at a wireless communication node, a first signal and a plurality of second signals to a wireless communication device, wherein:
the first signal comprises an indication to instruct the wireless communication device to reflect each of the plurality of second signals back towards the wireless communication node using an Intelligent Reflecting Surface (IRS) coupled to the wireless communication device, and
the plurality of second signals covers at least part of a serving area of the wireless communication node; and
receiving, at the wireless communication node, a respective reflected signal for each of the plurality of second signals from the IRS, wherein the respective reflected signal for each of the plurality of second signals is used for positioning computation of the wireless communication device.

11-16. (canceled)

17. A non-transitory computer readable medium storing computer-executable instructions which when executed cause the wireless communication node to perform the method of claim 10:

18-19. (canceled)

20. A method comprising:
receiving, at a wireless communication device, a first signal and a plurality of second signals from a wireless communication node, wherein the first signal comprises an indication to instruct the wireless communication device to reflect each of the plurality of second signals back towards the wireless communication node using an Intelligent Reflecting Surface (IRS) coupled to the wireless communication device; and
reflecting, at the wireless communication device, each of the plurality of second signals back towards the wireless communication node using the IRS for positioning computation of the wireless communication device, wherein each of the plurality of second signals is reflected to generate a respective plurality of reflected second signals, wherein the respective plurality of reflected second signals is focused towards the wireless communication node.

21. The method of claim 20, further comprising:
receiving each of the plurality of second signals at a respective different Angle of Arrival (AoA) from a plurality of AoAs, wherein the plurality of second signals covers an entire serving area of the wireless communication node.

22. The method of claim 21, wherein each of the plurality of AoAs is measured at the wireless communication device using one of the following: Capon's Minimum Variance method, MUltiple Signal Classification (MUSIC) method, Estimation of Signal Parameters via Rotational Invariance Techniques (ESPRIT) method, and Matrix-Pencil method.

23. The method of claim 20, wherein the first signal comprises the indication to instruct the wireless communication device to reflect each of the plurality of second signals back towards the wireless communication node using the IRS with a respective same direction as measured in the respective one of the plurality of AoAs, wherein the indication is:
transmitted through system information block (SIB) signaling;
transmitted through SIB Type 1 (SIB1) signaling;
transmitted through radio resource control (RRC) signaling;
transmitted through medium access control-control element (MAC-CE) signaling;
transmitted through downlink control information (DCI) signaling;
transmitted via a paging message; or
pre-configured in the wireless communication device.

24. The method of claim 23, wherein a respective one of the plurality of second signals comprises a respective downlink-positioning reference signal (DL-PRS), wherein the respective DL-PRS comprises a respective train of DL-PRS pulses, wherein the respective train of DL-PRS pulses comprises a respective first subset of DL-PRS pulses and a respective second subset of DL-PRS pulses, wherein:
the respective first subset of DL-PRS pulses is used to determine the respective AoA of the respective one of the plurality of second signals; and
the respective second subset of DL-PRS pulses is reflected by the IRS towards the wireless communication node with the respective same direction as measured in the respective AoA of the respective one of the plurality of second signals.

25. The method of claim 20, wherein the wireless communication device is configured to use a programmable IRS technology to reflect each of the plurality of second signals to generate the respective plurality of reflected second signals by modulating a user equipment (UE)-specific unique code onto the respective plurality of reflected second signals, wherein the UE-specific unique code is a UE identification (ID).

26. The method of claim 20, wherein each of the plurality of second signals is reflected by a plurality of reconfigurable reflecting elements in the IRS to generate the respective plurality of reflected second signals.

27. (canceled)

28. A non-transitory computer readable medium storing computer-executable instructions which when executed cause the at the wireless communication device to perform the method of claim 20.

29. Circuitry configured to cause the wireless communication device to perform the method of claim 20.

30-37. (canceled)
